(19) United States
(12) Patent Application Publication
(10) Pub. No.: US 2004/0246426 A1
(43) Pub. Date: Dec. 9, 2004

(54) Color pixel arrangement of display

(76) Inventors: Pei-Chang Wang, Taichung (TW); Tzu-Yun Hsu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/452,504

(22) Filed: Jun. 3, 2003

(51) Int. Cl. G02F 1/1343

(52) U.S. Cl. 349/146

(57) ABSTRACT

A pixel arrangement includes a plurality of pixels each having six sides. Each of the pixels having six adjacent pixels. The six sides of each of the pixels are connected to the six adjacent pixels respectively. Thus, each pixel is connected to the six adjacent pixels evenly and uniformly, thereby obtaining a better viewing effect. In addition, the hexagonal pixel arrangement can obtain a viewing effect greater than that of the rectangular pixel arrangement and the circular pixel arrangement.

### BACKGROUND OF THE INVENTION

1. Field of the Invention

The present invention relates to pixel arrangement, and more particularly to color pixel arrangement of display.

2. Description of the Related Art

A conventional color pixel of a planar display consists of multiple pixels. Usually, the pixels are arranged in a rectangular or circular manner. However, the viewing effect of the rectangular or circular pixel arrangement is limited, thereby affecting the aesthetic quality of the display.

### SUMMARY OF THE INVENTION

The present invention is to mitigate and/or obviate the disadvantage of the conventional pixel arrangement of an color pixel of a display.

The primary objective of the present invention is to provide a hexagonal pixel arrangement which can obtain a viewing effect greater than that of the rectangular pixel arrangement and the circular pixel arrangement.

Another objective of the present invention is to provide a pixel arrangement, wherein each pixel has six sides connected to the six adjacent pixels, thereby obtaining a better viewing effect.

A further objective of the present invention is to provide a pixel arrangement, wherein each pixel is connected to the six adjacent pixels evenly and uniformly, thereby obtaining a better viewing effect.

In accordance with the present invention, there is provided a pixel arrangement, comprising:

a plurality of pixels each having six sides;

each of the pixels having six adjacent pixels;

the six sides of each of the pixels are connected to the six adjacent pixels respectively.

Further benefits and advantages of the present invention will become apparent after a careful reading of the detailed description with appropriate reference to the accompanying drawings.

### BRIEF DESCRIPTION OF THE DRAWINGS

FIG. 1 is a schematic plan view of a pixel arrangement in accordance with the preferred embodiment of the present invention;

FIG. 2 is a schematic plan view showing connection of the scanning lines and the data lines of the pixel arrangement in accordance with the preferred embodiment of the present invention;

FIG. 3 is a schematic plan view of a double-pixel arrangement in accordance with the preferred embodiment of the present invention;

FIG. 4 is a schematic plan view of the double-pixel arrangement in accordance with another embodiment of the present invention; and

FIG. 5 is a schematic plan view of a triple-pixel arrangement in accordance with the preferred embodiment of the present invention.

### DETAILED DESCRIPTION OF THE INVENTION

Referring to the drawings and initially to FIG. 1, a pixel arrangement of a color pixel of a display in accordance with the preferred embodiment of the present invention comprises a plurality of pixels 10 each having six equal or non-equal sides 11. Preferably, each of the pixels 10 has six equal sides 11. In addition, each pixel 10 has six adjacent pixels 10, and each of the six sides 11 of each pixel 10 is located adjacent to or juxtaposed to a respective side 11 of the six adjacent pixels 10. In such a manner, each pixel 10 is connected to the six adjacent pixels 10 evenly and uniformly, thereby obtaining a better image viewing effect. Thus, the pixel arrangement is available for a liquid crystal display (LCD).

In practice, each of the pixels 10 is made of optical sensitive material, and is formed on an optical sensitive resistor. In addition, each of the pixels 10 is a colored optical film layer that is made by the procedures of exposure, development and water washing.

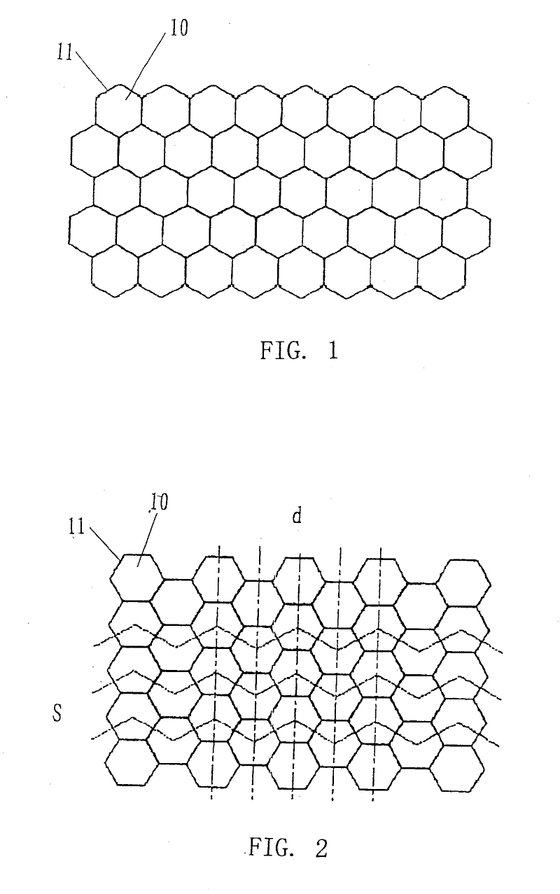

As shown in FIG. 2, the pixels 10 are driven by a plurality of curved scanning lines “S” and a plurality of linear data lines “d”.

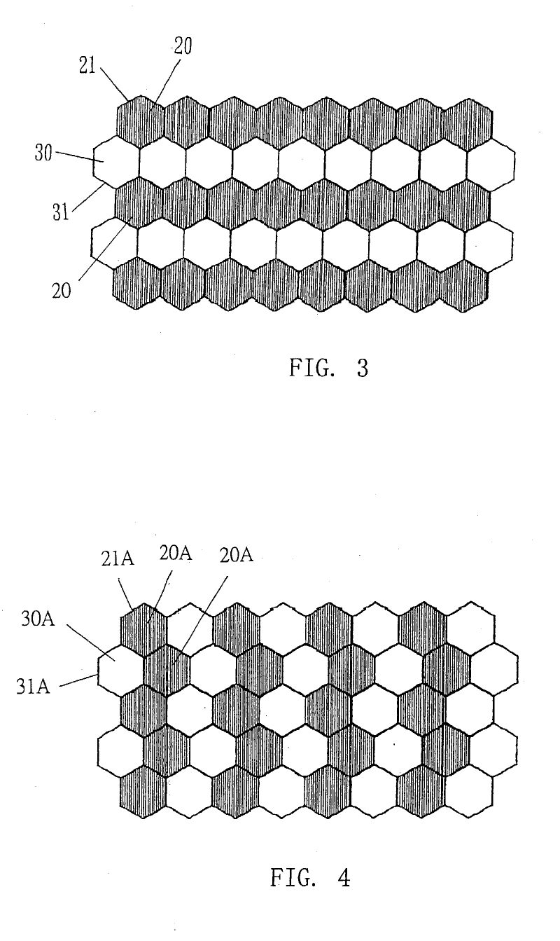

Referring to FIG. 3, a double-pixel arrangement in accordance with the preferred embodiment of the present invention comprises a plurality of first pixels 20 each having six equal sides 21, and a plurality of second pixels 30 each having six equal sides 31. Each of the first pixels 20 has a color different from that of each of second pixels 30. The first pixels 20 and the second pixels 30 are arranged in a transverse manner, and are arranged in a staggered manner. In addition, each first pixel 20 has four adjacent second pixels 30 and two adjacent first pixel 20, and four of the six sides 21 of each first pixel 20 are connected to the respective sides 31 of the four adjacent second pixels 30 and the other two of the six sides 21 of each first pixel 20 are connected to the respective sides 21 of the two adjacent first pixel 20. In such a manner, the first pixels 20 and second pixels 30 are connected evenly and uniformly, thereby obtaining a better image viewing effect.

Referring to FIG. 4, the double-pixel arrangement in accordance with another embodiment of the present invention comprises a plurality of first pixels 20A each having six equal sides 21A, and a plurality of second pixels 30A each having six equal sides 31A. Each of the first pixels 20A has a color different from that of each of second pixels 30A. The first pixels 20A and the second pixels 30A are arranged in a longitudinal manner, and are arranged in a staggered manner. In addition, each first pixel 20A has four adjacent second pixels 30A and two adjacent first pixel 20A, and four of the six sides 21A of each first pixel 20A are connected to the respective sides 31A of the four adjacent second pixels 30A and the other two of the six sides 21A of each first pixel 20A are connected to the respective sides 21A of the two adjacent first pixel 20A. In such a manner, the first pixels 20A and second pixels 30A are connected evenly and uniformly, thereby obtaining a better image viewing effect.

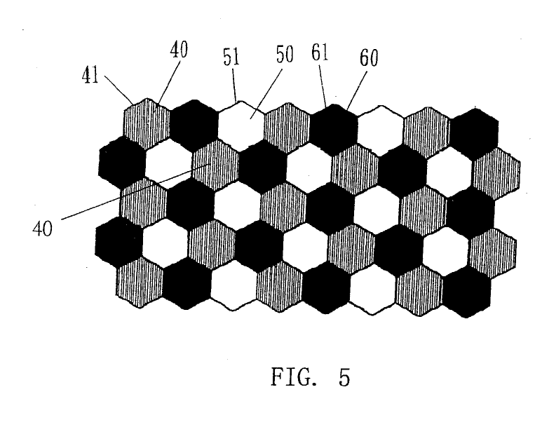

Referring to FIG. 5, a triple-pixel arrangement in accordance with the preferred embodiment of the present invention comprises a plurality of first pixels 40 each having six equal sides 41, a plurality of second pixels 50 each having six equal sides 51, and a plurality of third pixels 60 each having six equal sides 61. The first pixels 40, the second pixels 50 and the third pixels 60 have different colors. In addition, each first pixel 40 has three adjacent second pixels 50 and three adjacent third pixel 60, and three of the six sides 41 of each first pixel 40 are connected to the respective sides 51 of the three adjacent second pixels 50 and the other three of the six sides 41 of each first pixel 40 are connected to the respective sides 61 of the three adjacent third pixel 60. In such a manner, the first pixels 40, the second pixels 50 and the third pixels 60 are connected evenly and uniformly, thereby obtaining a better image viewing effect.

Accordingly, the pixel arrangement in accordance with the present invention is a hexagonal pixel arrangement which can obtain a viewing effect greater than that of the rectangular pixel arrangement and the circular pixel arrangement. Thus, the pixel arrangement in accordance with the present invention is available for the liquid crystal display (LCD), plasma display, organic light-emitting diode (OLED), organic elector-luminescence (OEL), polymer light-emitting diode (PLED), active matrix OLED (AMOLED), passive matrix OLED (PMOLED) or the like.

While the preferred embodiment(s) of the present invention has been shown and described, it will be apparent to those skilled in the art that various modifications may be made in the embodiment(s) without departing from the spirit of the present invention. Such modifications are all within the scope of the present invention.

What is claimed is:

1. A pixel arrangement, comprising:
a plurality of pixels each having six sides;
each of the pixels having six adjacent pixels;
the six sides of each of the pixels are connected to the six adjacent pixels respectively.

2. The pixel arrangement in accordance with claim 1, wherein each of the pixels has six equal sides.

3. The pixel arrangement in accordance with claim 1, wherein the pixel arrangement is a hexagonal pixel arrangement.

4. The pixel arrangement in accordance with claim 1, wherein the pixels are connected and driven by a plurality of curved scanning lines and a plurality of linear data lines.

5. The pixel arrangement in accordance with claim 1, wherein the pixels comprises a plurality of first pixels each having six sides, and a plurality of second pixels each having six sides.

6. The pixel arrangement in accordance with claim 5, wherein each of the first pixels has a color different from that of each of second pixels.

7. The pixel arrangement in accordance with claim 5, wherein the first pixels and the second pixels are arranged in a transverse manner.

8. The pixel arrangement in accordance with claim 5, wherein the first pixels and the second pixels are arranged in a staggered manner.

9. The pixel arrangement in accordance with claim 5, wherein each first pixel has four adjacent second pixels and two adjacent first pixel, and four of the six sides of each first pixel are connected to the respective sides of the four adjacent second pixels and the other two of the six sides of each first pixel are connected to the respective sides of the two adjacent first pixel.

10. The pixel arrangement in accordance with claim 5, wherein the first pixels and the second pixels are arranged in a longitudinal manner.

11. The pixel arrangement in accordance with claim 1, wherein the pixels comprises a plurality of first pixels each having six equal sides, a plurality of second pixels each having six equal sides, and a plurality of third pixels each having six equal sides.

12. The pixel arrangement in accordance with claim 11, wherein the first pixels, the second pixels and the third pixels have different colors.

13. The pixel arrangement in accordance with claim 11, wherein each first pixel has three adjacent second pixels and three adjacent third pixel, and three of the six sides of each first pixel are connected to the respective sides of the three adjacent second pixels and the other three of the six sides of each first pixel are connected to the respective sides of the three adjacent third pixel.

14. The pixel arrangement in accordance with claim 1, wherein the pixel arrangement is used in a liquid crystal display.

15. The pixel arrangement in accordance with claim 1, wherein the pixel arrangement is used in the liquid crystal display (LCD), plasma display, organic light-emitting diode (OLED), organic elector-luminescence (OEL), polymer light-emitting diode (PLED), active matrix OLED (AMOLED), and passive matrix OLED (PMOLED).
